(19) United States
(12) Patent Application Publication
(10) Pub. No.: US 2008/0309889 A1
(43) Pub. Date: Dec. 18, 2008

(54) Speech Prompter Apparatus

(75) Inventor: Stan Rivera, San Ramon, CA (US)

Correspondence Address: HANCOCK HUGHEY LLP, P.O. BOX 1208, SISTERS, OR, 97759, US

(73) Assignee: Keynote Products LLC, Cheyenne, WY (US)

(21) Appl. No.: 12/125,185

(22) Filed: May 22, 2008

Related U.S. Application Data
(60) Provisional application No. 60/936,218, filed on Jun. 18, 2007.

(51) Int. Cl. G03B 21/28; G03B 21/14

(52) U.S. Cl. 353/98; 353/122

(57) ABSTRACT

A portable and easily used speech prompter apparatus relies upon a standard laptop computer and a coated display screen that is attachable to a table, podium or to a floor stand. The display screen is attached to flexible tubing, which allows the screen to be adjusted easily by the users, and is positioned such that the images displayed on the computer screen are reflected from the screen so that a user may read the images from the display screen. Software is installed on the laptop, but standard software may also be used to display non-scrolling text or other prompts. The speech prompter may be used in a first mode in which images on the computer screen are inverted and reversed and are thus displayed in a normal orientation on the display screen. The speech prompter may also be used in a second mode in which images on the computer screen remain in a normal orientation, are reflected onto a mirror and then onto the display screen where they appear normally oriented. In both modes the text and images on the computer screen may be scrolling or non-scrolling.

### TECHNICAL FIELD

This invention relates generally to apparatus for use in public speaking to prompt the speaker with an electronic, visual display of the text of a speech, and more particularly to a readily portable speech prompter.

### BACKGROUND OF THE INVENTION

Speech prompters, commonly referred to with the term teleprompters, are used by many public speakers. In a nutshell, a speech prompter is a display device on which text of a speech is displayed so that the speaker may refer to the text during the presentation, even allowing the speaker to read the text of the speech without the audience being aware that the speaker is being cued. In many respects, a speech prompter is analogous to old-fashioned cue cards. However, speech prompters of the kind referred to herein are electronic in nature, and in many cases the audience is entirely unaware that a speech prompter is being used.

There are many different types of speech prompters on the market. Most typically, these utilize a video camera of some kind, a reflective surface such as a piece of glass with a special, partially reflective coating, and video equipment. In many instances, the video camera is fitted with a special shroud and the glass is mounted to the camera at an angle relative to the lens. In any case, a video image comprising text of the speech is transmitted from the video camera to the glass, and the text is displayed on the glass in a manner that the speaker may read it, or at least refer to the text during the speech. The text typically scrolls as the speaker progresses through the presentation, and from the audience's perspective it does not appear like the speaker is reading the text. This is especially true for speakers who have experience using a speech prompter and it allows for speeches to be delivered without the need for the speaker to memorize the text, or to refer to hardcopy notes or text on the podium.

While available speech prompters are very useful and have found widespread acceptance, they have several characteristics that tend to make them difficult to use in many settings. For example, they tend to be fairly expensive and therefore out of reach from an economic perspective for many who would benefit from their use. Part of the reason for the relatively high cost is that these systems use split beam glass for the reflector, and this kind of glass is quite expensive. Commercially available speech prompters also use a dedicated LCD display. The LCD display scrolls the mirrored text, but the reflective glass is the speaker's viewing area, not the LCD screen. Moreover, specialized software is typically required for operation of such prompters, and the video equipment used in many kinds of speech prompters is expensive.

Commercially available speech prompters also require expensive video equipment and, often, floor stands for supporting the viewing screen (glass), and the video camera. This equipment is as noted often expensive, and moreover can be relatively large and unwieldy, and difficult for many to operate because of the complexity of the equipment.

There is a need therefore for speech prompters that are more personal in nature—that is, which are less expensive than commercially available models, and which may be operated with a minimum amount of dedicated specialized equipment. Such a speech prompter would be simple for most users to operate with standard equipment and minimally complex apparatus.

### SUMMARY OF THE INVENTION

In a first illustrated embodiment the invention comprises a speech prompter that relies upon a standard laptop computer and a viewing screen that is attachable to a table, podium or to a floor stand. The viewing screen is attached to flexible tubing, which allows the screen to be adjusted easily by the users. Software is installed on the laptop that allows text on the viewing screen to be read by the user. The software allows the text to be inverted and reversed so that the text is displayed on the viewing screen in a normal orientation. Standard or specialized software may be used to display text, images and other prompts in scrolling or non-scrolling manner. In a second illustrated embodiment the laptop is used with a specialized reflective mirror attachment that fits onto the computer. Text displayed on the computer's monitor is reflected from the mirror and onto the viewing screen. Text (both scrolling and non-scrolling) is displayed on the viewing screen in a non-mirrored manner.

The invention defines a speech prompter apparatus that is configured to accept reflected images of scrolled text from a laptop computer screen, such that the image can be viewed and read by an individual on a viewing screen. Because the text is displayed directly onto the screen from the LCD display of the laptop computer, the need for video equipment is eliminated. The apparatus may be used either with or without an optional reflective mirror.

### BRIEF DESCRIPTION OF THE DRAWINGS

The invention will be better understood and its numerous objects and advantages will be apparent by reference to the following detailed description of the invention when taken in conjunction with the following drawings and images.

FIG. 1 is a perspective side view of a first illustrated embodiment of a speech prompter apparatus according to the present invention, and illustrating the lines of sight and lines of reflection with arrows.

FIG. 2 is a perspective side view of a second illustrated embodiment of a speech prompter apparatus according to the present invention, illustrating the lines of sight and lines of reflection with arrows.

FIG. 3 is a perspective view of the speech prompter apparatus shown in FIG. 2, taken from the user's perspective.

FIG. 4 is perspective side view of the component parts of a speech prompter apparatus according to the present invention.

### DETAILED DESCRIPTION OF THE PREFERRED EMBODIMENTS

With reference now to the drawing figures, speech prompter apparatus 10 may be used either with or without an optional mirror reflector, depending upon the manner in which the user desires the apparatus to be set up and used. Apparatus 10 is described below with reference to both embodiments, that is, with and without the optional reflective mirror.

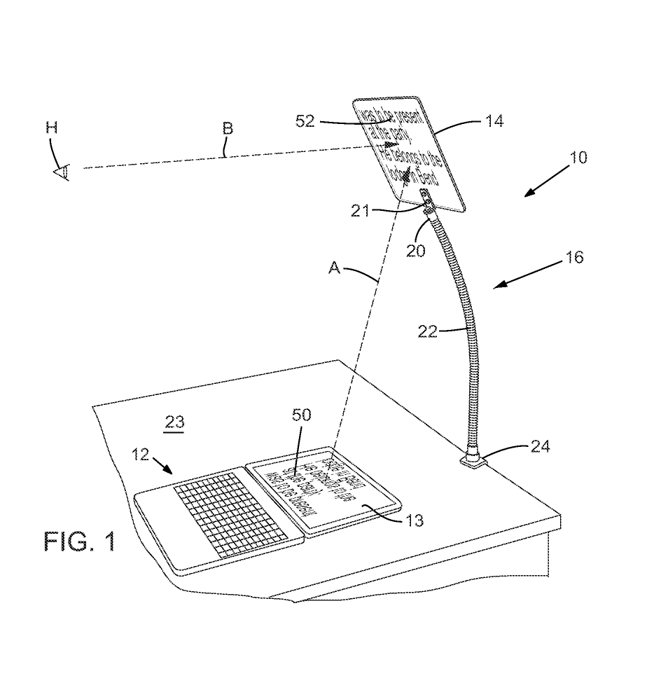

With reference first to FIG. 1, the first embodiment of apparatus 10 comprises the following component parts: a laptop computer 12 and a viewing screen 14 mounted on a support stand 16. Each component will be separately described.

Computer 12 may be any standard laptop computer that has a conventional LCD display 13 or some other kind of display screen on which images are displayed. As described in greater detail below, the software that is used on computer 12 when it is operating with apparatus 10 may be either conventional office-type software, or specialized software designed for use with speech prompters, and which will allow text to actively scroll on the screen. Regardless of the type of software used, in a first embodiment the software must allow the text to be displayed on LCD display 13 in an inverted and reversed orientation. Although there are numerous kinds of software that will function with the present invention, a preferred software application allows text to be presented as white text on a black background, allows the text to be reversed horizontally, and either independently or along with reversing the text horizontally, allows the text to be inverted. The preferred software also allows scrolling as an option. When the text does not scroll, the user prompts the software to jump from page to page of the presentation.

Alternately, the software may allow the text that is displayed on LCD display 13 to be reversed. In this case, the user may effectively invert the text by turning the computer 12 180 degrees on the desktop, which results in the text being both reversed and inverted with respect to the way that the text on the display 13 to be reflected onto the viewing screen 14.

It will be appreciated that as used herein, the word “image” is used generically to refer to text and other materials that may be displayed on the computer's screen, and thus may be displayed on the viewing screen of the present invention.

Viewing screen 14 preferably is a display panel comprising 60/40 split beam glass, treated on both sides with specialized reflective coating. Such glass is commercially available and provides approximately 60% reflected light and 40% transmitted light. This type of viewing screen provides sufficient brightness to allow text displayed on the screen to be viewed in normal indoor lighting conditions, without the need to dim the room lights to read the text displayed on the viewing screen. At the same time, the screen is relatively non-visible to the audience. Of course, other split beam glass is available and will work well with the present invention, including 70/30 split beam glass, and 80/20 split beam glass.

Alternately, the viewing screen 14 may be plastic in which a specialized coating is applied to one side of the plastic. As with the glass viewing screen, a plastic viewing screen of the type used for apparatus 10 is commercially available. Preferably, the plastic viewing screen provides a 70% reflected light and 30% transmitted light, which provides sufficient brightness and clarity for the plastic screen to be used in typical indoor lighting conditions, although other reflection/transmission ratios will work well. The viewing screen 14 is any appropriate size, and is typically about 10 inches by 10 inches in size, although the size may vary widely depending upon the circumstances.

The viewing screen 14 is mounted on the “upper” end of support stand 16 in any appropriate manner, such as with a bracket 20 that has screws 21 such as thumb screws that extend through holes drilled through the viewing screen and which are easily removed. Bracket 20 is mounted to support stand 16, which includes a length of flexible gooseneck tubing 22 that is of an appropriate length. The bracket 20 may be mounted to tubing 22 either in a permanent manner or with a conventional quick connect/disconnect type of fitting, and the gooseneck tubing may be metal or plastic. If metal tubing is used it is preferably covered with plastic or vinyl for protective purposes and to provide a finished appearance.

The “lower” end of the tubing 22—i.e., lower with reference to the ground plane when apparatus 10 is set up as shown in FIG. 1, is provided with a quick connect/disconnect coupling so that the tubing and the viewing screen mounted on it may be mounted in any number of positions, locations. For example, a C-clamp 24 may be fitted to the lower end of the tubing so that the viewing screen may be attached to a table, desk or podium as shown in FIG. 1. Just as well, the tubing may be mounted to a standard microphone stand so that the viewing screen may be positioned near a podium or desk. Likewise, the quick connect/disconnect coupling may be mounted to a base, such as wood or metal, that acts as a stand for the viewing screen.

The flexible tubing 22 allows the viewing screen 14 to be adjusted to an infinite number of appropriate viewing positions, at different heights and angles, in order to accommodate any speaker and any condition.

Operation of apparatus 10 shown in FIG. 1 will now be described. Computer 12 is laid on an appropriate surface (such as desktop 23) and the LCD screen is opened fully so that the screen 13 lies flat on the desktop 23 along with the keyboard portion of the computer. The viewing screen 14 is attached to the desktop (or otherwise positioned adjacent the LCD screen) and is positioned relative to the LCD screen 13 on laptop 12 such that the display from the LCD screen is reflected directly onto the viewing screen 14. It will be appreciated that in this orientation, any text that is displayed on the LCD screen in a normal orientation will be displayed both upside down and in a mirror image on the viewing screen. As used herein, the words “normal orientation” when used to refer to text displayed on the computer's screen or the viewing screen means text that is displayed in the orientation exemplified by the text in this patent—that is, font that is oriented in a standard manner and which is read from left to right across the screen or page. As such, in order for a user to be able to read text in a normal orientation on viewing screen 14, the text 50 displayed on the computer's LCD screen 13 must be inverted and reversed. Many software programs, including many commercially available office applications, allow this display orientation without any modification of the software. Alternately, there are commercially available software applications that provide for inverted, mirrored display. Such software typically also allows for other functionality, including controlled speed scrolling, reverse scrolling, stopping the scrolling and pausing.

An example of a text 50 displayed on LCD 13 is shown in FIG. 1, where the text is inverted and reversed. The text 50 in FIG. 1 reads “was to be present at the party. He belongs to the lodge in Bend.” While this inverted and reversed text 50 would be very difficult to read on the LCD screen 13, when the display is reflected off of viewing screen 14 it is oriented in a normal manner (as shown in FIG. 1) and can be easily read by the user. This is shown with reference number 52, which identifies normally oriented text.

Thus, when the image on the LCD screen is inverted and mirrored, the image displayed on the viewing screen 14 is once again inverted and reversed, resulting in the text 52, which is again oriented in a normal orientation, which allows the user to read the text normally. If the software on laptop 12 is of the type that allows active scrolling, the display shown on the viewing screen 14 also will actively scroll. Of course, the software used on laptop 14 may be of the type that provides for single-frame images, such as Microsoft™ PowerPoint™. In the case of apparatus 10 shown in FIG. 1, assuming the image is displayed on the LCD screen in the inverted, reversed mode, then the display on viewing screen 14 will be analogous to a cue card.

During set up of the apparatus 10, the position of the viewing screen 14 relative to LCD screen 13 is adjusted to maximize the ability to visualize the images displayed on the viewing screen. The reflected light paths are shown schematically in FIG. 1 with arrows A and B. Thus, the inverted and reversed image on LCD 13 is reflected onto viewing screen 14, as illustrated by the light path designated with arrow A. Likewise, the image on viewing screen 14 is seen by a user H along light path B as being displayed in a normal orientation. The image on the viewing screen may be scrolled if appropriate and if the software that generates the images is capable of scrolling.

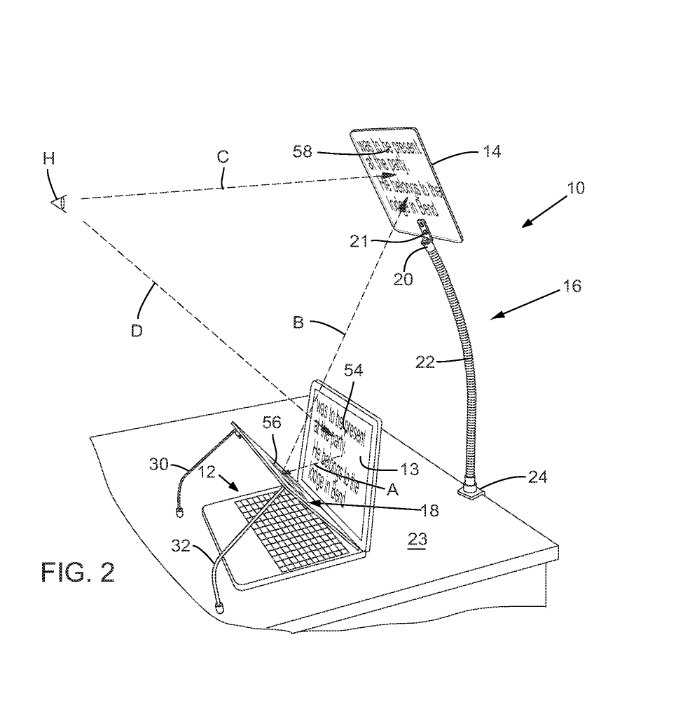

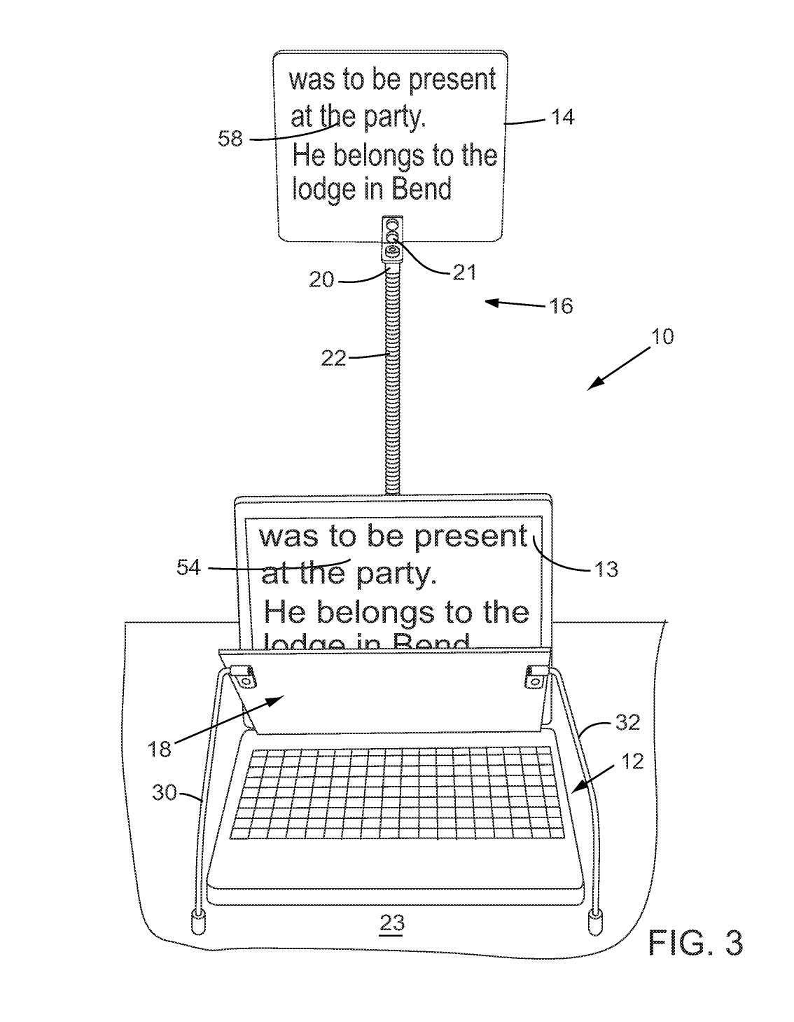

As noted previously, apparatus 10 may be operated according to a second embodiment in which an optional reflective mirror is used to display text. This embodiment is shown in FIGS. 2 and 3, and when the optional reflective mirror is used there is no need to rely on software to invert and reverse the display on the computer's LCD screen.

With reference now to FIGS. 2 and 3, when apparatus 10 is operated with optional reflective mirror 18 it is not necessary to have the display on the LCD screen of computer 12 inverted and mirrored. It will be understood that the viewing screen 14 is identical to that described above. Optional reflective mirror 18 comprises a plastic or glass mirror that is preferably about 10 inches by 12 inches. The mirror 18 is designed to be mounted on laptop 12 as shown in FIGS. 2 and 3, and such that the reflective side of the mirror is facing the laptop's LCD display 13, and is angularly oriented relative to the LCD display 13. When mounted on laptop 12 as shown in the figures, the base of the mirror rests near the point where the LCD display panel is hinged to the base of the computer 12 keyboard portion. There are many appropriate ways in which to provide for detachably mounting the mirror 18 to a laptop. In one preferred embodiment, a pair of small flexible metallic arms 30, 32 are attached to the back side of mirror 18. The distal ends of the arms rest on the desktop or podium, and the arms may be adjusted so that the angle of the mirror relative to the LCD display suits the user.

In FIG. 2 the position of a user's head is represented with H. It will be appreciated from review of the figures that the image on the laptop's LCD screen 13 is oriented normally, as shown with text 54 in FIGS. 2 and 3. The image of text 52 displayed on the LCD of computer 12 is reflected on mirror 18. There, the text is in a mirror image (reference number 56, FIG. 2) of the text 54 on the LCD screen. Next, the image of text is displayed on viewing screen 14, where it is again mirrored (reference number 56, FIG. 2), rendering the image orientation as viewed by a viewer at H in a normal manner. The viewer thus sees the images from the computer in a standard orientation that can be read very easily.

The reflected light paths are shown schematically in FIG. 2 with arrows A and B. The image displayed on LCD screen 13 is thus reflected along light path A onto mirror 18. The now-reversed image on mirror 18 is reflected along light path B onto viewing screen 14, where the image is again reversed and thus displayed in a normal orientation. The user H views the image on viewing screen 14 along sight path C. As noted earlier, the image on the viewing screen 14 may be scrolled if appropriate and if the software that generates the images is capable of scrolling.

With continuing reference to FIGS. 2 and 3, it may be seen that text 54 displayed on LCD 13 is oriented in the normal manner. As detailed above, the image on the computer's LCD is first reversed at mirror 18, then again reversed at viewing screen 14, where it will be displayed in the normal orientation to a viewer at H. This normally oriented text is shown in FIG. 3 with text image 54, which is how the user at H will perceive the text on screen 14.

When the optional mirror 18 is used as shown in FIGS. 2 and 3, a speaker may read text from two separate locations: the display screen 14 and the LCD 13 on the laptop (the text is displayed on the laptop when viewed from H in regular manner, i.e., not mirrored). These two displays both show the text in the proper orientation, and the user's line of sight from position H is shown with arrows C and D. This allows the user to move his or her eyes from one location to another while speaking. Such eye movement by the speaker during a speech gives the audience the impression that the speaker is not reading the text of the presentation, and instead that the speaker has memorized the speech or is improvising.

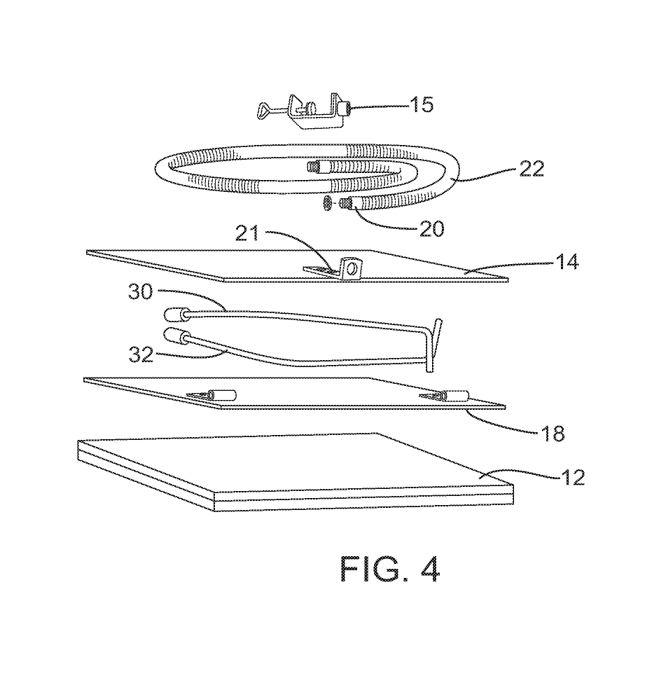

The speech prompter 10 according to the present invention is modular and compact, and may be easily transported with the laptop computer 12, often in the original carrying case provided with the laptop. FIG. 4 illustrates all of the component parts for speech prompter 10, including the optional mirror 18. From the view of FIG. 4 it will be appreciated that the entire apparatus is easily transported and stored when not in use.

From the foregoing description and the drawings appended hereto it will be apparent that the speech prompter 10 is operable in a first mode in which the images displayed on the computer display screen are oriented in a reversed and inverted orientation, and in a second mode in which the imaged displayed on the computer display screen are oriented normally. In the first mode, no mirror 18 is required (FIG. 1). In the second mode, mirror 18 is utilized as shown in FIGS. 2 and 3.

While the present invention has been described in terms of a preferred embodiment, it will be appreciated by one of ordinary skill that the spirit and scope of the invention is not limited to those embodiments, but extend to the various modifications and equivalents as defined in the appended claims.

1. Speech prompter, comprising:
a computer having a screen display associated therewith for displaying images; and
a viewing screen mounted in operable proximity to the screen display of the computer so that images displayed on the screen display of the computer are displayed on the viewing screen.

2. The speech prompter according to claim 1 in which the images are displayed on the screen display of the computer in reversed and inverted orientation.

3. The speech prompter according to claim 2 in which the images displayed on the viewing screen are oriented in a normal orientation.

4. The speech prompter according to claim 1 in which the images are displayed on the screen display of the computer in a normal orientation.

5. The speech prompter according to claim 4 including a mirror mounted in proximity to the screen display of the computer so that text and images displayed on the computer screen display are reflected from the mirror to the viewing screen and the images on the viewing screen are in a normal orientation.

6. The speech prompter according to claim 1 in which the viewing screen is split beam glass.

7. The speech prompter according to claim 1 operable in a first mode in which a user may visualize images in a normal orientation on the viewing screen only, and a second mode in which a user may visualize images in a normal orientation on the viewing screen and the computer screen display.

8. A method of displaying images on a viewing screen for use by a speaker as a speech prompter, comprising the steps of:
a) generating images and displaying the generated images on the screen associated with a computer;
b) positioning a viewing screen proximate the computer screen; and
c) transmitting the images from the computer's screen to a viewing screen so that the images are displayed on the viewing screen in a normal orientation.

9. The method according to claim 8 including the step of displaying the generated images on the computer screen in a reversed and inverted orientation.

10. The method according to claim 8 including the step of displaying the generated images on the computer screen in a normal orientation.

11. The method according to claim 10 including the step of positioning a mirror in an operative position proximate the computer screen so that the images on the computer screen are reflected from the mirror.

12. The method according to claim 11 in which the images displayed on the computer screen are reflected from the mirror in a reversed orientation and are transmitted to the viewing screen where the image orientation is again reversed.

13. The method according to claim 8 including the step of causing the images to scroll on the computer screen and on the viewing screen.

14. The method according to claim 12 including the step of causing the images to scroll on the computer screen and on the viewing screen.

15. Speech prompter apparatus, comprising:
a laptop computer having a display screen, said display screen having images displayed thereon; and
viewing screen means in proximity to the computer display screen for reflecting the images displayed on the computer display screen in a normal orientation to a speaker.

16. The speech prompter apparatus according to claim 15 including image orientation means for displaying the images on the computer display screen in an inverted and reversed orientation.

17. The speech prompter apparatus according to claim 15 wherein the images displayed on the computer display screen are in a normal orientation.

18. The speech prompter apparatus according to claim 17 including first image orientation reversing means for reversing the orientation of the images displayed on the computer display screen.

19. The speech prompter apparatus according to claim 18 including second image orientation reversing means for reversing the orientation of the images reversed by the first image orientation reversing means.

20. The speech prompter apparatus according to claim 15 operable in a first mode in which the images displayed on the computer display screen are oriented in a reversed and inverted orientation, and in a second mode in which the imaged displayed on the computer display screen are oriented normally.
